(19) United States
(12) Patent Application Publication
(10) Pub. No.: US 2021/0304338 A1
(43) Pub. Date: Sep. 30, 2021

(54) METHODS, SYSTEMS, APPARATUSES AND DEVICES FOR FACILITATING PROCESSING OF A DIVORCE BETWEEN TWO PARTIES

(71) Applicant: JUNIKIA COLEMAN BANKS, SMYRNA, GA (US)

(72) Inventor: JUNIKIA COLEMAN BANKS, SMYRNA, GA (US)

(21) Appl. No.: 17/216,174

(22) Filed: Mar. 29, 2021

Related U.S. Application Data
(60) Provisional application No. 63/000,605, filed on Mar. 27, 2020.

(51) Int. Cl. G06Q 50/18; G06Q 40/02

(52) U.S. Cl. CPC G06Q 50/182; G06Q 40/02; G06Q 50/188

(57) ABSTRACT

Disclosed herein is a method for facilitating processing of a divorce between two parties, in accordance with some embodiments. The method may include a step of receiving a divorce request for initiating the divorce from one or more of a first device and a second device associated with at least one a first party of the two parties and a second party of the two parties, retrieving a divorce form, transmitting the divorce form, receiving one or more of at least one first party information and at least one second party information, analyzing one or more of the at least one first party information and the at least one second party information based on at least one divorce law, determining a type of the divorce, generating a divorce solution for proceeding with the divorce and transmitting the divorce solution to one or more of the first device and the second device.

The current application claims a priority to the U.S. Provisional Patent application Ser. No. 63/000,605 filed on Mar. 27, 2020. The current application is filed on Mar. 29, 2021 while Mar. 27, 2021 was on a weekend.

### TECHNICAL FIELD

Generally, the present disclosure relates to the field of data processing. More specifically, the present disclosure relates to methods, systems, apparatuses and devices for facilitating processing of a divorce between two parties.

### BACKGROUND

Divorce rates are skyrocketing due to debt obligations and infidelity, and irreconcilable differences. However, divorce proceedings can be very costly and complex. The major costs are related to with the time and expertise required to generate the required paperwork. For example, in uncontested divorce proceedings, a number of documents need to be prepared and filed with the courts. Experience in often required in reading and understanding their content of the documents.

Further, the divorce proceedings can be emotionally taxing for the parties involved. For example, the contested divorce proceedings involve exchanging information, settlement negotiations and physical meeting of the involved parties.

Accordingly, there is a need for simplifying the divorce process. Further, there is a need for process to minimize interaction between the involved parties. The present invention aims to address the above-mentions issues by providing a strategic cost-effective filing and collaborative divorce probability forecast platform that amalgamates legal technology, actuarial algorithm, and arbitration.

Therefore, there is need for methods, systems, apparatuses and devices for facilitating processing of a divorce between two parties that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating processing of a divorce between two parties, in accordance with some embodiments. The method may include a step of receiving, using a communication device, a divorce request for initiating the divorce from one or more of a first device and a second device associated with at least one a first party of the two parties and a second party of the two parties. Further, the method may include a step of retrieving, using a storage device, a divorce form based on the divorce request. Further, the divorce form facilitates collecting of information from the two parties for the processing of the divorce. Further, the method may include a step of transmitting, using the communication device, the divorce form to one or more of the first device and the second device. Further, the method may include a step of receiving, using the communication device, one or more of at least one first party information associated with the first party and at least one second party information associated with the second party from at least one first device and the second device. Further, the method may include a step of analyzing, using a processing device, one or more of the at least one first party information and the at least one second party information based on at least one divorce law. Further, the method may include a step of determining, using the processing device, a type of the divorce based on the analyzing. Further, the method may include a step of generating, using the processing device, a divorce solution for proceeding with the divorce based the determining. Further, the method may include a step of transmitting, using the communication device, the divorce solution to one or more of the first device and the second device.

Further disclosed herein is a system of facilitating processing of a divorce between two parties, in accordance with some embodiments. The system may include a communication device, a storage device and a processing device. Further, the communication device may be configured for performing a step of receiving a divorce request for initiating the divorce from one or more of a first device and a second device associated with at least one a first party of the two parties and a second party of the two parties. Further, the communication device may be configured for performing a step of transmitting a divorce form to one or more of the first device and the second device. Further, the communication device may be configured for performing a step of receiving one or more of at least one first party information associated with the first party and at least one second party information associated with the second party from at least one first device and the second device. Further, the communication device may be configured for performing a step of transmitting a divorce solution to one or more of the first device and the second device. Further, the communication device may be configured for performing a step of a storage device communicatively coupled with the communication device. Further. Further, the storage device may be configured for performing a step of retrieving the divorce form based on the divorce request. Further, the divorce form facilitates collecting of information from the two parties for the processing of the divorce. Further, the storage device may be configured for performing a step of a processing device communicatively coupled with the communication device and the storage device. Further. Further, the processing device may be configured for performing a step of analyzing one or more of the at least one first party information and the at least one second party information based on at least one divorce law. Further, the processing device may be configured for performing a step of determining a type of the divorce based on the analyzing. Further, the processing device may be configured for performing a step of generating the divorce solution for proceeding with the divorce based the determining.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method for facilitating processing of a divorce between two parties, in accordance with some embodiments.

FIG. 4 is a continuation flow chart of FIG. 3.

FIG. 5 is a flow chart of a method for facilitating processing of a divorce between two parties, in accordance with some embodiments.

FIG. 6 is a flow chart of a method for facilitating processing of a divorce between two parties, in accordance with some embodiments.

FIG. 7 is a flow chart of a method for facilitating processing of a divorce between two parties, in accordance with some embodiments.

FIG. 8 is a flow chart of a method for facilitating processing of a divorce between two parties, in accordance with some embodiments.

FIG. 9 is a flow chart of a method for facilitating processing of a divorce between two parties, in accordance with some embodiments.

FIG. 10 is a flow chart of a method for facilitating processing of a divorce between two parties, in accordance with some embodiments.

FIG. 11 is a flow chart of a method for facilitating processing of a divorce between two parties, in accordance with some embodiments.

FIG. 12 is a continuation flow chart of FIG. 11.

FIG. 13 is a flow chart of a method for facilitating processing of a divorce between two parties, in accordance with some embodiments.

FIG. 14 is a flow chart of a method for facilitating processing of a divorce between two parties, in accordance with some embodiments.

FIG. 15 is a block diagram of a system for facilitating processing of a divorce between two parties, in accordance with some embodiments.

FIG. 16 is block diagram of an environment in which the present disclosure may operate.

FIG. 17 is a block diagram of a system, in accordance with some embodiments.

FIG. 18 is a flowchart of a method for divorce processing in accordance with some embodiments.

FIG. 19 is a partial user experience flow diagram, in accordance with some embodiments.

FIG. 20 is a continuation user experience flow diagram of FIG. 19.

FIG. 21 is a continuation user experience flow diagram of FIG. 19.

FIG. 22 is a continuation user experience flow diagram of FIG. 19.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating processing of a divorce between two parties, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview

Disclosed is a system, method and platform for facilitating divorce processing in accordance with some embodiments.

A person (applicant) seeking a divorce may first fill out a generic form answering questions required for divorce within the court system in all states. Based on the information provided, algorithm perform keyword matching that are pertinent to annulment, contested or uncontested divorce. The applicant then gets a legal forecast. Further, links to the websites of the courts in their city, state and county is also provided to the applicant.

In an uncontested divorce case, the applicant may fill out the paper work and e-file the documents directly with the courts.

In a contested divorce case, the involved parties may elect to meet with a mediator virtually. Further, a divorcee decree may be drafted and e-filed with the courts. Parents may also complete and take a free parenting class online.

The disclosed technology seeks to provide individuals from all walks of life and corners of the world, an opportunity to easily file a divorce. The technology provides a fast, affordable, and reliable way to get divorce. The technology combines mediation and logistic behind actuary probability forecast to provide a seamless divorce process. The technology provides an avenue to diminish the financial hardship, emotional stress, judicial overload, and time of a divorce. The process is seamless and can help obtain a divorce 100% online in 30 days or less without publication and 60 days or less with publication.

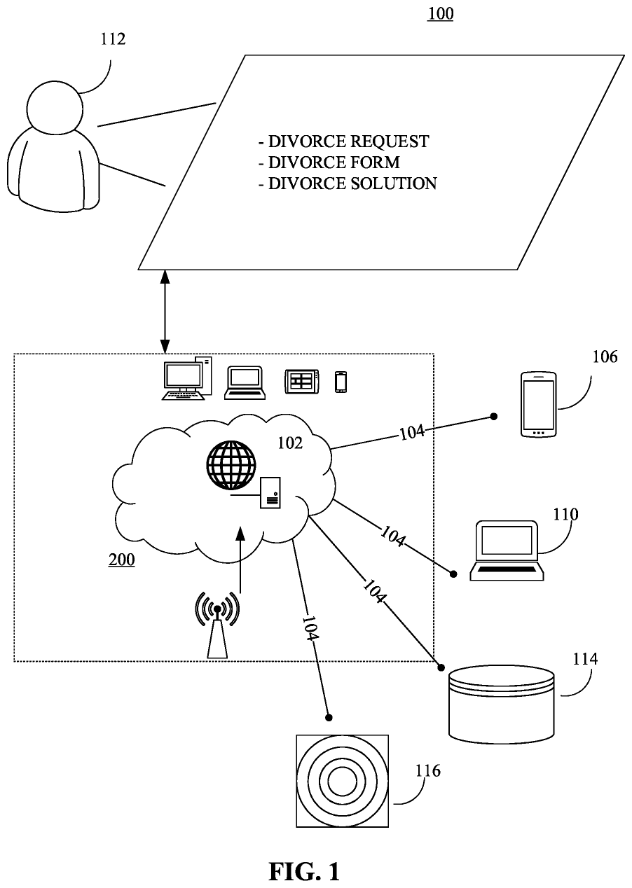

Referring now to figures, FIG. 1 is an illustration of an online platform 100 consistent with various embodiments of the present disclosure. By way of non-limiting example, the online platform 100 to enable facilitating processing of a divorce between two parties may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

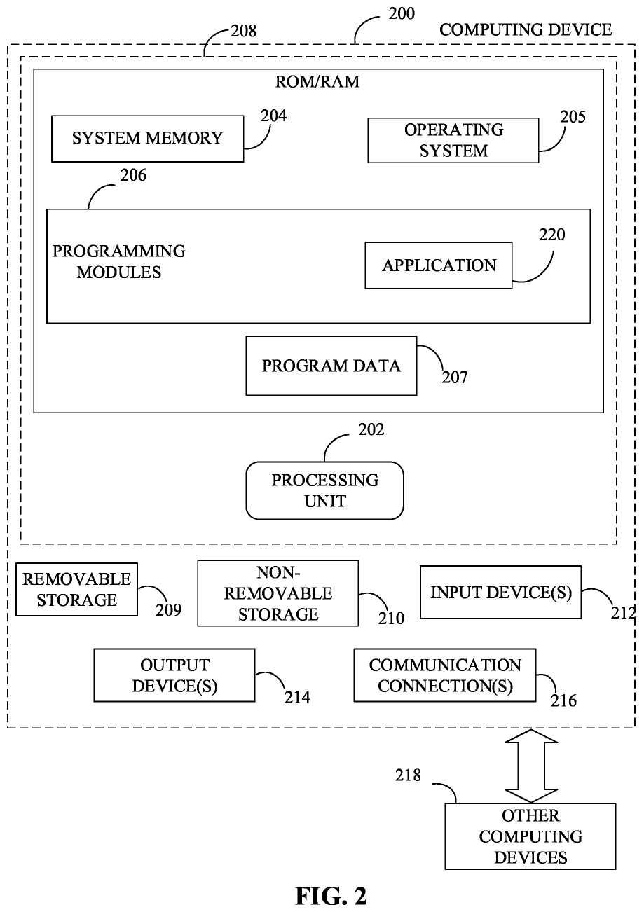

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

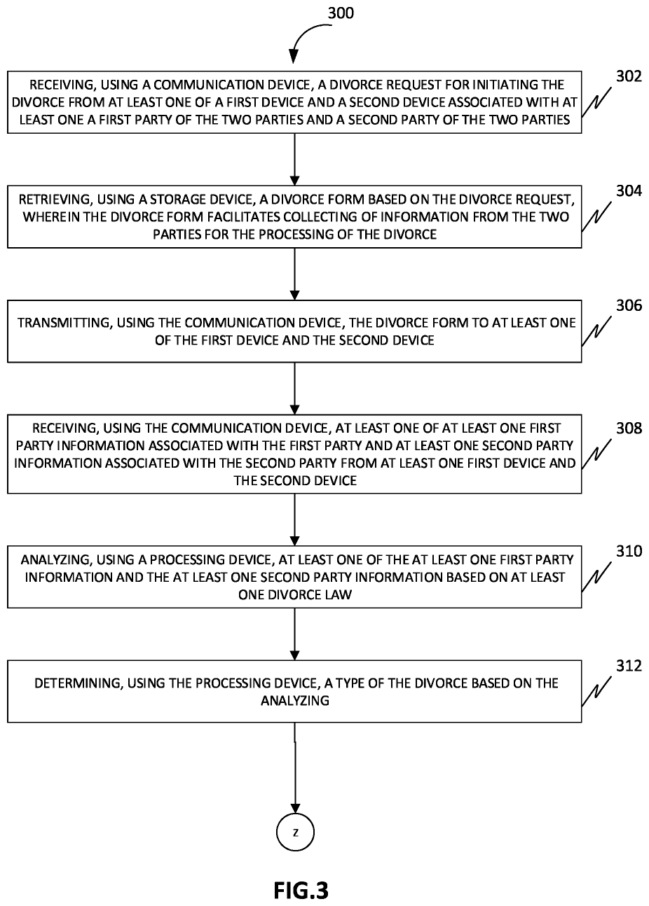

FIG. 3 is a flow chart of a method 300 for facilitating processing of a divorce between two parties, in accordance with some embodiments.

Further, at 302, the method 300 may include receiving, using a communication device, a divorce request for initiating the divorce from at least one of a first device and a second device associated with at least one a first party of the two parties and a second party of the two parties.

Further, at 304, the method 300 may include retrieving, using a storage device, a divorce form based on the divorce request. Further, the divorce form facilitates collecting of information from the two parties for the processing of the divorce.

Further, at 306, the method 300 may include transmitting, using the communication device, the divorce form to at least one of the first device and the second device.

Further, at 308, the method 300 may include receiving, using the communication device, at least one of at least one first party information associated with the first party and at least one second party information associated with the second party from at least one first device and the second device.

Further, at 310, the method 300 may include analyzing, using a processing device, at least one of the at least one first party information and the at least one second party information based on at least one divorce law.

Further, at 312, the method 300 may include determining, using the processing device, a type of the divorce based on the analyzing.

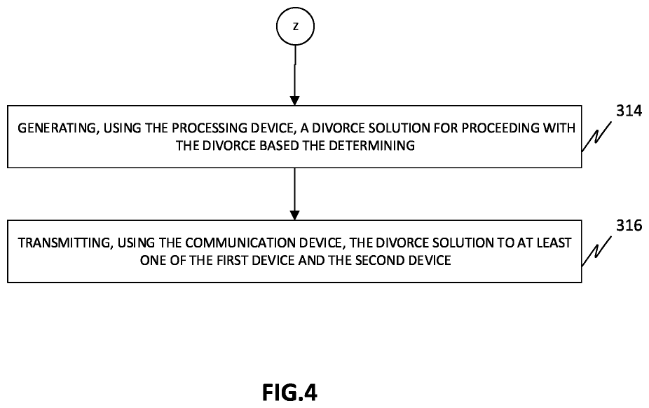

FIG. 4 is a continuation flow chart of FIG. 3. Further, at 314, the method 400 may include generating, using the processing device, a divorce solution for proceeding with the divorce based the determining.

Further, at 316, the method 400 may include transmitting, using the communication device, the divorce solution to at least one of the first device and the second device.

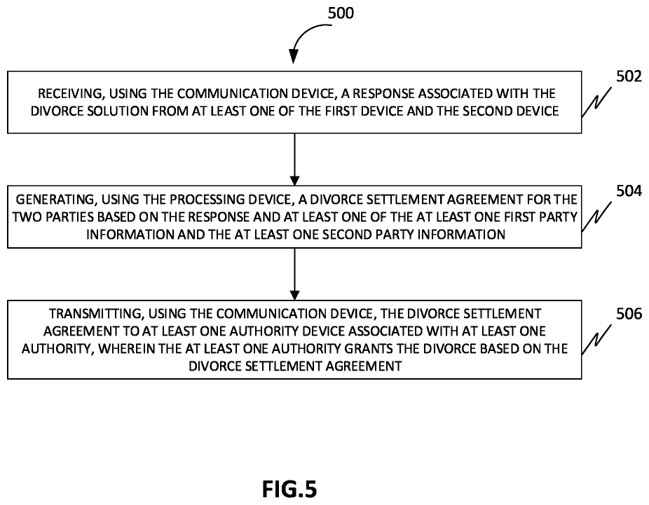

FIG. 5 is a flow chart of a method 500 for facilitating processing of a divorce between two parties, in accordance with some embodiments. Further, at 502, the method 500 may include receiving, using the communication device, a response associated with the divorce solution from at least one of the first device and the second device. Further, at 504, the method 500 may include generating, using the processing device, a divorce settlement agreement for the two parties based on the response and at least one of the at least one first party information and the at least one second party information. Further, at 506, the method 500 may include transmitting, using the communication device, the divorce settlement agreement to at least one authority device associated with at least one authority. Further, the at least one authority grants the divorce based on the divorce settlement agreement.

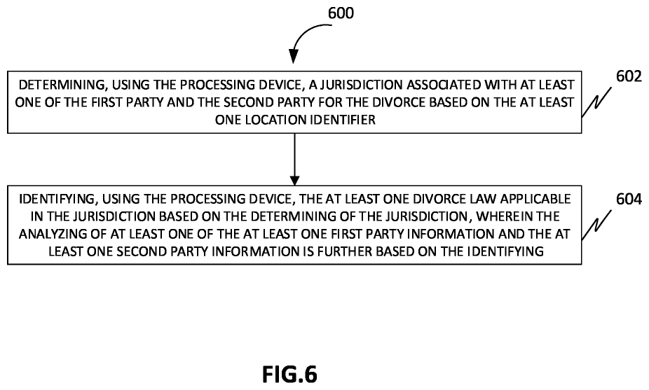

FIG. 6 is a flow chart of a method 600 for facilitating processing of a divorce between two parties, in accordance with some embodiments. Further, at least one of the at least one first party information and the at least one second party information may include a location identifier of a location associated with at least one of the first party and the second party.

Further, at 602, the method 600 may include determining, using the processing device, a jurisdiction associated with at least one of the first party and the second party for the divorce based on the at least one location identifier. Further, at 604, the method 600 may include identifying, using the processing device, the at least one divorce law applicable in the jurisdiction based on the determining of the jurisdiction. Further, the analyzing of at least one of the at least one first party information and the at least one second party information is further based on the identifying.

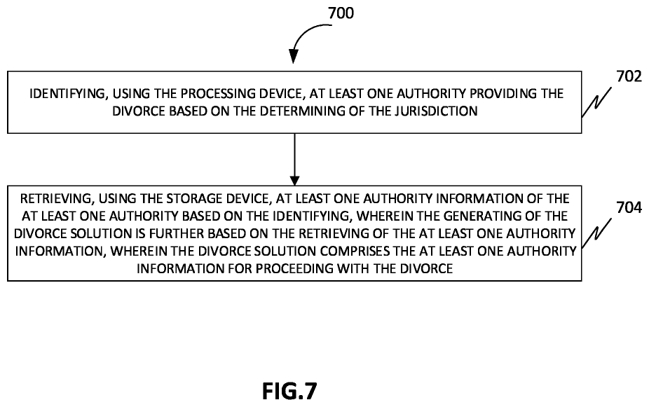

FIG. 7 is a flow chart of a method 700 for facilitating processing of a divorce between two parties, in accordance with some embodiments. Further, at 702, the method 700 may include identifying, using the processing device, at least one authority providing the divorce based on the determining of the jurisdiction. Further, at 704, the method 700 may include retrieving, using the storage device, at least one authority information of the at least one authority based on the identifying. Further, the generating of the divorce solution is further based on the retrieving of the at least one authority information. Further, the divorce solution comprises the at least one authority information for proceeding with the divorce.

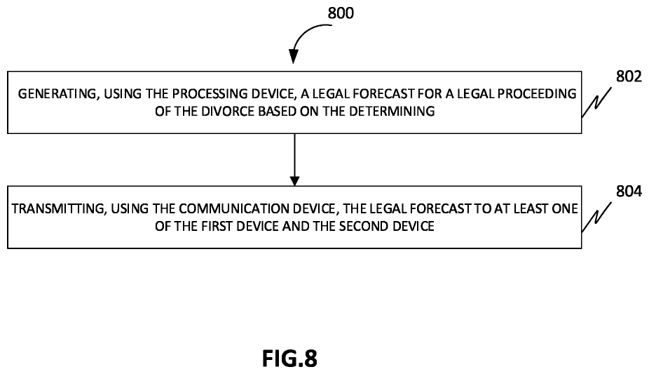

FIG. 8 is a flow chart of a method 800 for facilitating processing of a divorce between two parties, in accordance with some embodiments. Further, at 802, the method 800 may include generating, using the processing device, a legal forecast for a legal proceeding of the divorce based on the determining Further, at 804, the method 800 may include transmitting, using the communication device, the legal forecast to at least one of the first device and the second device.

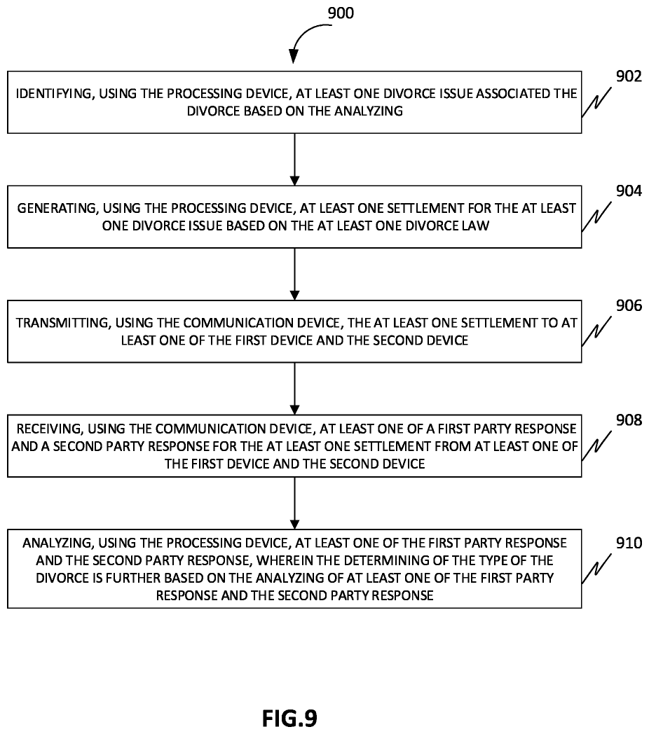

FIG. 9 is a flow chart of a method 900 for facilitating processing of a divorce between two parties, in accordance with some embodiments. Further, at 902, the method 900 may include identifying, using the processing device, at least one divorce issue associated the divorce based on the analyzing. Further, at 904, the method 900 may include generating, using the processing device, at least one settlement for the at least one divorce issue based on the at least one divorce law. Further, at 906, the method 900 may include transmitting, using the communication device, the at least one settlement to at least one of the first device and the second device. Further, at 908, the method 900 may include receiving, using the communication device, at least one of a first party response and a second party response for the at least one settlement from at least one of the first device and the second device. Further, at 910, the method 900 may include analyzing, using the processing device, at least one of the first party response and the second party response. Further, the determining of the type of the divorce is further based on the analyzing of at least one of the first party response and the second party response.

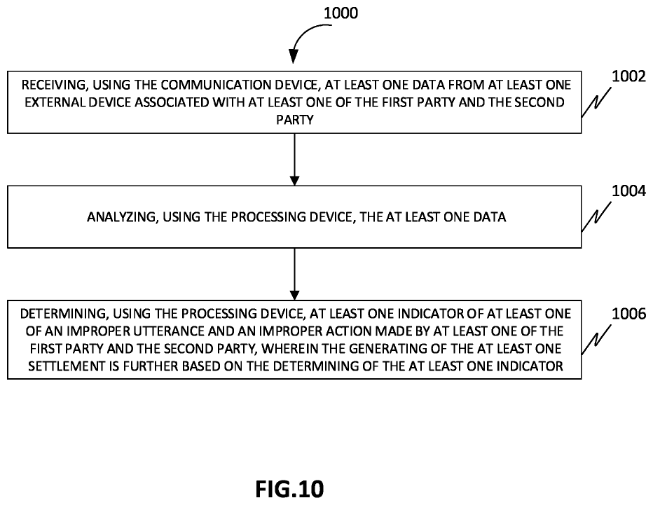

FIG. 10 is a flow chart of a method 1000 for facilitating processing of a divorce between two parties, in accordance with some embodiments. Further, at 1002, the method 1000 may include receiving, using the communication device, at least one data from at least one external device associated with at least one of the first party and the second party. Further, at 1004, the method 1000 may include analyzing, using the processing device, the at least one data. Further, at 1006, the method 1000 may include determining, using the processing device, at least one indicator of at least one of an improper utterance and an improper action made by at least one of the first party and the second party. Further, the generating of the at least one settlement is further based on the determining of the at least one indicator.

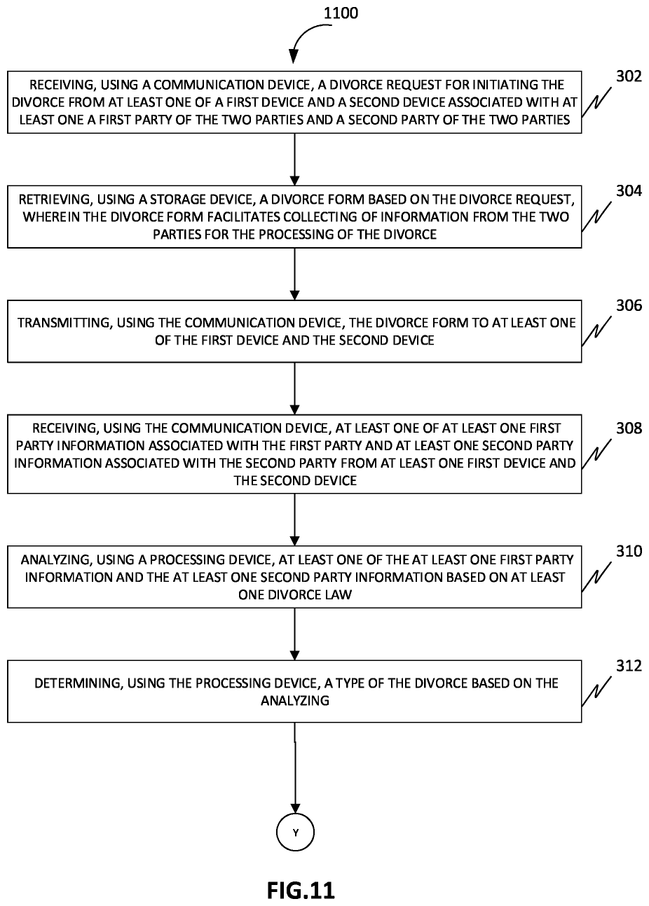

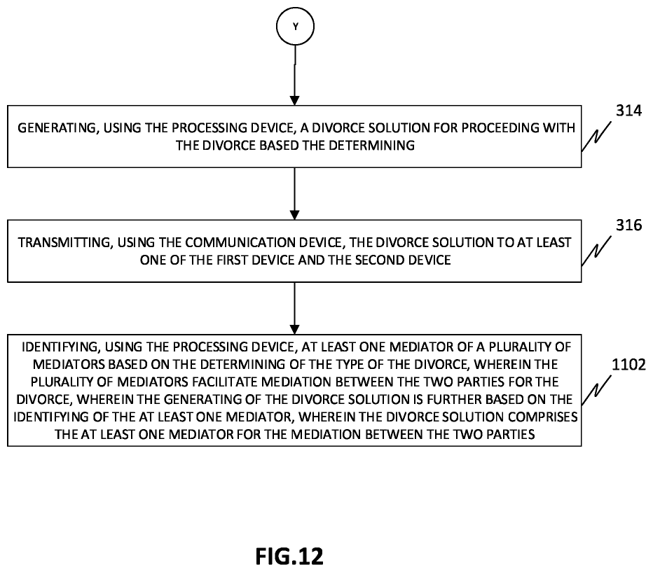

FIG. 11 is a flow chart of a method 1100 for facilitating processing of a divorce between two parties, in accordance with some embodiments. FIG. 12 is a continuation flow chart of FIG. 11. Further, at 1102, the method 1100 may include identifying, using the processing device, at least one mediator of a plurality of mediators based on the determining of the type of the divorce. Further, the plurality of mediators facilitate mediation between the two parties for the divorce. Further, the generating of the divorce solution is further based on the identifying of the at least one mediator. Further, the divorce solution comprises the at least one mediator for the mediation between the two parties.

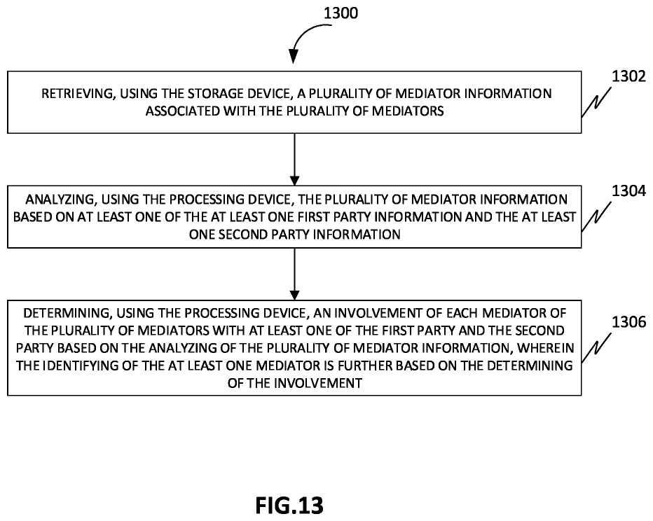

FIG. 13 is a flow chart of a method 1300 for facilitating processing of a divorce between two parties, in accordance with some embodiments. Further, at 1302, the method 1300 may include retrieving, using the storage device, a plurality of mediator information associated with the plurality of mediators. Further, at 1304, the method 1300 may include analyzing, using the processing device, the plurality of mediator information based on at least one of the at least one first party information and the at least one second party information. Further, at 1306, the method 1300 may include determining, using the processing device, an involvement of each mediator of the plurality of mediators with at least one of the first party and the second party based on the analyzing of the plurality of mediator information. Further, the identifying of the at least one mediator is further based on the determining of the involvement.

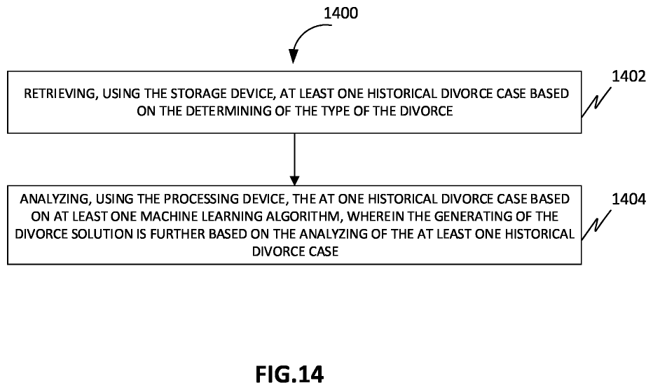

FIG. 14 is a flow chart of a method 1400 for facilitating processing of a divorce between two parties, in accordance with some embodiments. Further, at 1402, the method 1400 may include retrieving, using the storage device, at least one historical divorce case based on the determining of the type of the divorce. Further, at 1404, the method 1400 may include analyzing, using the processing device, the at one historical divorce case based on at least one machine learning algorithm. Further, the generating of the divorce solution is further based on the analyzing of the at least one historical divorce case.

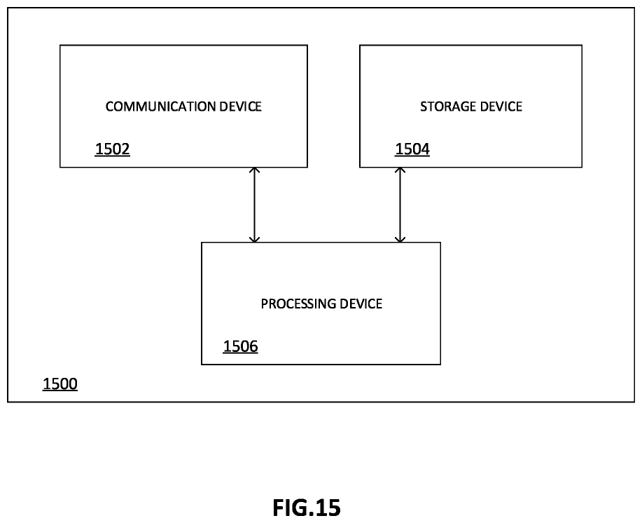

FIG. 15 is a block diagram of a system 1500 for facilitating processing of a divorce between two parties, in accordance with some embodiments. The system 1500 may include a communication device 1502, a storage device 1504 and a processing device 1506.

Further, the communication device 1502 may be configured for performing a step of receiving a divorce request for initiating the divorce from one or more of a first device and a second device associated with at least one a first party of the two parties and a second party of the two parties.

Further, the communication device 1502 may be configured for performing a step of transmitting a divorce form to one or more of the first device and the second device.

Further, the communication device 1502 may be configured for performing a step of receiving one or more of at least one first party information associated with the first party and at least one second party information associated with the second party from at least one first device and the second device.

Further, the communication device 1502 may be configured for performing a step of transmitting a divorce solution to one or more of the first device and the second device.

The storage device 1504 may be communicatively coupled with the communication device. 1502

Further, the storage device 1504 may be configured for performing a step of retrieving the divorce form based on the divorce request. Further, the divorce form facilitates collecting of information from the two parties for the processing of the divorce.

The processing device 1506 may be communicatively coupled with the communication device. 1502

Further, the processing device 1506 may be configured for performing a step of analyzing one or more of the at least one first party information and the at least one second party information based on at least one divorce law.

Further, the processing device 1506 may be configured for performing a step of determining a type of the divorce based on the analyzing.

Further, the processing device 1506 may be configured for performing a step of generating the divorce solution for proceeding with the divorce based the determining.

In some embodiments, the communication device 1502 may be configured for performing a step of receiving a response associated with the divorce solution from one or more of the first device and the second device. Further, the communication device 1502 may be configured for performing a step of transmitting a divorce settlement agreement to at least one authority device associated with at least one authority. Further, the at least one authority grants the divorce based on the divorce settlement agreement. Further, the processing device 1506 may be configured for generating the divorce settlement agreement for the two parties based on the response and at least one of the at least one first party information and the at least one second party information.

Further, at least one of the at least one first party information and the at least one second party information may include a location identifier of a location associated with at least one of the first party and the second party. Further, the processing device 1506 may be configured for determining a jurisdiction associated with at least one of the first party and the second party for the divorce based on the at least one location identifier and identifying the at least one divorce law applicable in the jurisdiction based on the determining of the jurisdiction. Further, the analyzing of at least one of the at least one first party information and the at least one second party information may be further based on the identifying.

In some embodiments, the processing device 1506 may be configured for identifying at least one authority providing the divorce based on the determining of the jurisdiction. Further, the storage device 1504 may be configured for retrieving at least one authority information of the at least one authority based on the identifying. Further, the generating of the divorce solution may be based on the retrieving of the at least one authority information. Further, the divorce solution may include the at least one authority information for proceeding with the divorce.

In some embodiments, the processing device 1506 may be configured for performing a step of generating a legal forecast for a legal proceeding of the divorce based on the determining. Further, the communication device 1502 may be configured for performing a step of transmitting the legal forecast to one or more of the first device and the second device.

In some embodiments, the processing device 1506 may be configured for performing a step of identifying at least one divorce issue associated the divorce based on the analyzing. Further, the processing device 1506 may be configured for performing a step of generating at least one settlement for the at least one divorce issue based on the at least one divorce law. Further, the processing device 1506 may be configured for performing a step of analyzing one or more of a first party response and a second party response. Further, the determining of the type of the divorce may be further based on the analyzing of one or more of the first party response and the second party response. Further, the communication device 1502 may be configured for performing a step of transmitting the at least one settlement to one or more of the first device and the second device. Further, the communication device 1502 may be configured for performing a step of receiving one or more of the first party response and the second party response for the at least one settlement from one or more of the first device and the second device.

In some embodiments, the communication device 1502 may be configured for receiving at least one data from at least one external device associated with at least one of the first party and the second party. Further, the processing device 1506 may be configured for analyzing the at least one data and determining at least one indicator of at least one of an improper utterance and an improper action made by at least one of the first party and the second party. Further, the generating of the at least one settlement may be based on the determining of the at least one indicator.

In some embodiments, the processing device 1506 may be configured for identifying at least one mediator of a plurality of mediators based on the determining of the type of the divorce. Further, the plurality of mediators may facilitate mediation between the two parties for the divorce. Further, the generating of the divorce solution may be based on the identifying of the at least one mediator. Further, the divorce solution may include the at least one mediator for the mediation between the two parties.

In some embodiments, the storage device 1504 may be configured for retrieving a plurality of mediator information associated with the plurality of mediators. Further, the processing device 1506 may be configured for analyzing the plurality of mediator information based on at least one of the at least one first party information and the at least one second party information and determining an involvement of each mediator of the plurality of mediators with at least one of the first party and the second party based on the analyzing of the plurality of mediator information. Further, the identifying of the at least one mediator may be based on the determining of the involvement.

In some embodiments, the storage device 1504 may be configured for retrieving at least one historical divorce case based on the determining of the type of the divorce. Further, the processing device 1506 may be configured for analyzing the at one historical divorce case based on at least one machine learning algorithm. Further, the generating of the divorce solution may be based on the analyzing of the at least one historical divorce case.

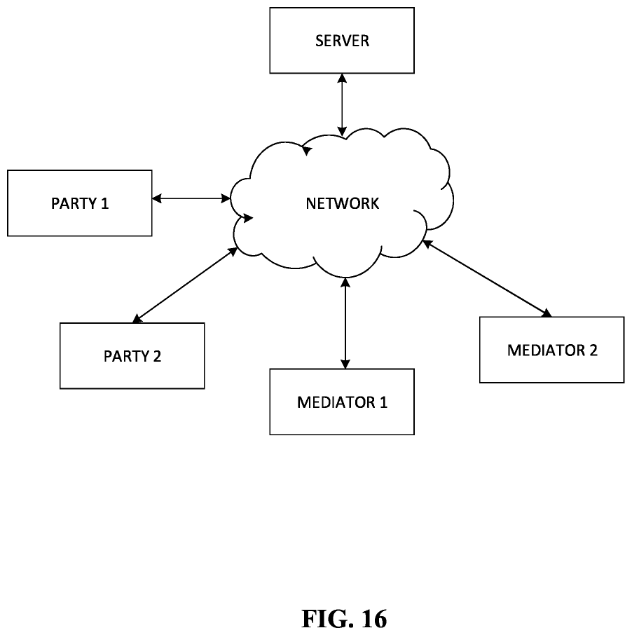

FIG. 16 is block diagram of an environment in which the present disclosure may operate. The environment may include a number of users using electronic communication devices to connect to a divorce processing server via a network (such as, the Internet). The users may include parties involved in a divorce case. Further, the users may include mediators that may facilitate mediation between the parties involved in a divorce case.

A user may use their electronic communication device to connect to the server to download and install a divorce processing software application. For example, the divorce processing software application may be a smartphone application for a device platform, such as, but not limited to, BlackBerry™, Symbian™, Android™, iPhone™, and Windows Mobile™. Then, the user may use the divorce processing software application to initiate a divorce process.

Alternatively, the server may provide the divorce processing software application as a website, such that the user can access the divorce processing software application website via an Internet Browser, such as, but not limited to, Microsoft Internet Explorer, Google Chrome, Mozilla Firefox, Apple's Safari and Opera.

Further, the server may maintain a list of mediators that may facilitate mediation between the parties involved in a divorce case.

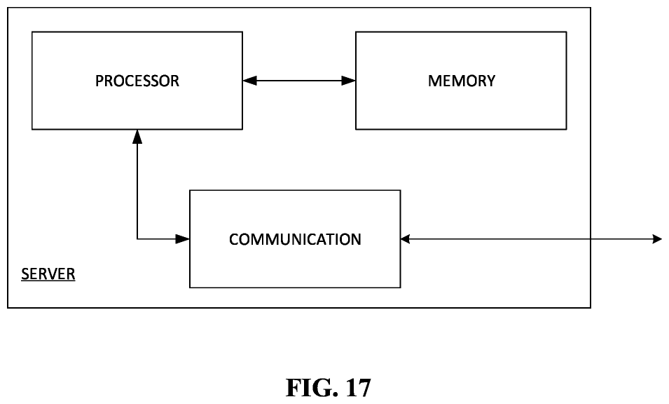

FIG. 17 is a block diagram of a system, in accordance with some embodiments. The system may include a memory to store software instructions and data. The system may also include a processor, which may be configured to obtain the instructions from the memory and execute the instructions.

The data may include downloadable copy of the divorce processing software application. Further, the data may include a list of mediators that may facilitate mediation between the parties involved in a divorce case. The data may also include legal information (such as, local laws).

The system may also include a communication module configured to communicate with one or more users.

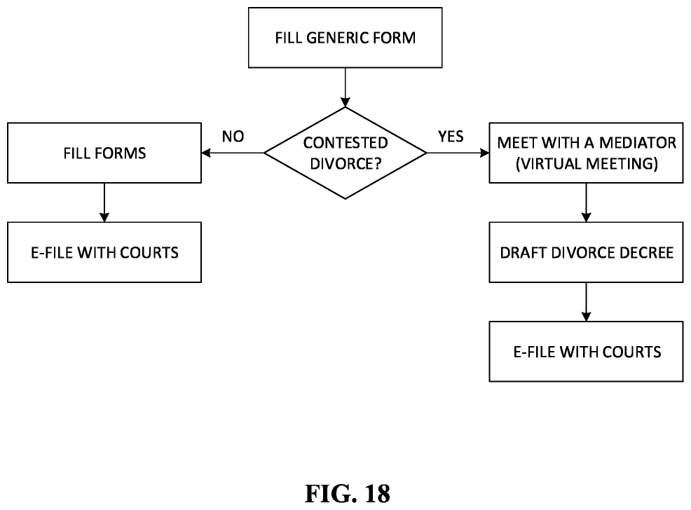

FIG. 18 is a flowchart of a method for divorce processing in accordance with some embodiments. A user (party 1) may initiate a divorce process by using the divorce processing software application. The party 1 is a petitioner in this case. First, the party 1 may fill out information in a generic divorce form. The generic divorce form may be used to obtain information required for divorce within the court system in all states. The generic divorce form may include fields such as, but not limited to, name, address, phone, date/place of birth, social security number, occupation, number of children and reason for seeking divorce. Further, the generic divorce form may include spouse's name, address, phone, date/place of birth, social security number, occupation.

Then, the divorce processing software application may analyze the information provided to determine the type of divorce (i.e. contested or uncontested or annulment). An uncontested divorce is one where the spouses agree on all the issues raised by the divorce. The issues raised by divorce include one or more of division of property/debt, custody of any children and payment of child and spousal support. A contested divorce is one where the spouses disagree on some or all of the issues raised by the divorce. An annulment is a legal procedure which cancels a marriage between a man and a woman Annulling a marriage is as though it is completely erased—legally, it declares that the marriage never technically existed and was never valid. This determination may be based on keyword analysis. Further, it may also include analyzing responses to a set of predetermined survey questions provided to the applicant. Additionally, the analysis may take into account a jurisdiction within which the applicant resides. Accordingly, local laws etc. may also be presented to the party 1.

Further, a legal forecast may be provided to the party 1. Also, links to the websites of all the courts in their city, state and county may also be provided to the party 1.

If an uncontested divorce case is determined, then the party 1 may fill the forms and e-file the forms with a court via the website of the respective court. Further, a copy of the application may be served to the respondent (party 2, the party 1's spouse).

In a contested divorce case is determined, then the divorce processing software application may present a list of mediators that may facilitate mediation between the involved parties. The mediators may be identified based on a registry and also based on information provided by both parties so that the mediator is neutral. Further, a conflict check may be performed by the platform to ensure that the mediator is not related to any of the involved parties.

Subsequently, once a mediator is selected a virtual mediation may be facilitated by the divorce processing software application where both the parties and the mediator may communicate in a video call. Additionally, the divorce processing software application may enable the mediator to get on a 1-on-1 call with either party within the same video call by selectively putting the other party on hold.

Further, a divorce decree or a settlement agreement may be drafted and e-filed with a court via the website of the respective court.

One or more steps of the method for divorce processing may be performed by a user using the divorce processing software application.

The divorce processing software application may assist in completing all the paperwork. The divorce processing software application may also provide case management to allow the involved parties to discuss the case in order to streamline proceedings.

The divorce processing software application may be called “IDIVORCEU”.

iDivorceU Brand Logo: The iDivorceU brand logo is designed to reduce intimidation that traditionally surrounds a divorce or separation. The split heart is used to represent the letter ‘v’ and is not referenced to as ‘broken’ indicating failure or other negative connotations.

The brand color selection serves two purposes. One is to represent the heritage as a component of the Web Wed family of applications. The second is to remain gender neutral and provide a subtle element of technical minded system.

The font has a slight rounded bezel which translates to youth, or renewed life. The WIFI heart compliments both the Web Wed parent company brand while signaling this is a cloud-based service and not a website for a divorce attorney which is commonly found Online.

iDivorceU Brand Icon Mark: In several instances the full logo will not be able to be displayed. Such as if an app or web icon. This can also play a role in overall brand development as it will serve as an additional visual reference when users begin seeing it in various mediums.

This logo can be presented on a solid background or as a standalone item but must retain the safety area around it for proper recognition.

iDivoirceU Font: The fonts selected have been licensed and/or are open source selections that will be used to identify iDivorceU across all mediums. Should these fonts be unavailable a substitute of Helvetica is permitted but must follow the same weight guidelines mentioned below. Headlines and slogans on all media. Raleway or Open Sans should be used for bidy text on all media and retain a font size no larger than 12 pt.

iDivorceU Brand Photography: Images that are used to represent the iDivorceU brand should remain positive and refrain from sad, or unhappy people. This should be seen as a transition period where iDivorceU will help facilitate and expedite. Not an argumentative, fight yielding, grueling process in which people wish to eject from. This will help to ensure the service is considered neutral for both parties evolved and not be used to determine the outcome or take sides in a dispute.

iDivorceU Brand Graphics: iDivorceU is an online service that is part of the internet of things. Because of the services primarily on-line use it is important that icons align with the brands image.

Documents will be transferred and stored as well as made available for e-signing and should maintain a clean strong simple to understand scheme.

These are a few of the primary icons required in the service and will be used through the interface.

iDivorceU Web Stylization: The iDivorceU website and mobile platform will provide a step by step, wizard style user centered interactions. The user will be provided with very general questions during each stage and be allowed to stop and begin where they left off at any point during the process.

iDivorceU is a cross-platform mobile application that will revolutionize the divorce industry, by providing an optical indirect human experience. The objective is to merge the two most powerful elements of the world: Law and Technology, to afford individuals from all walks of life and corners of the world, the opportunity to divorce on an affordable global platform. Uniquely, the development of our raw technology has unlocked the doors to a fast, affordable, and reliable way to get divorce. We have combines mediation and logistic behind actuary probability forecast to provide a seamless divorce process.

In an age where divorce rates are skyrocketing due to debt obligations and infidelity, and irreconcilable differences. iDivorceU offers a necessary avenue to diminish the financial hardship, emotional stress, judicial overload, and time of an divorce.

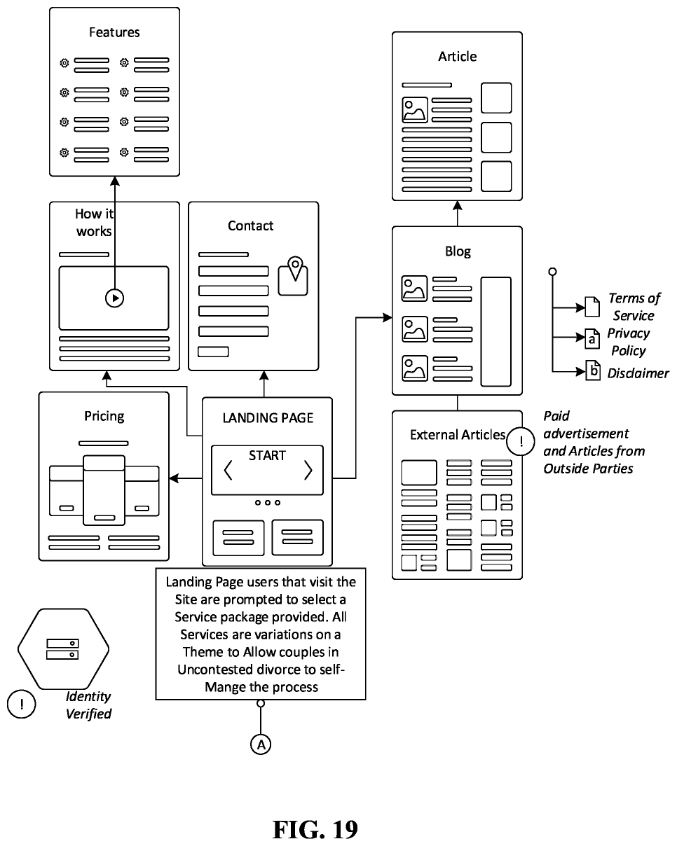

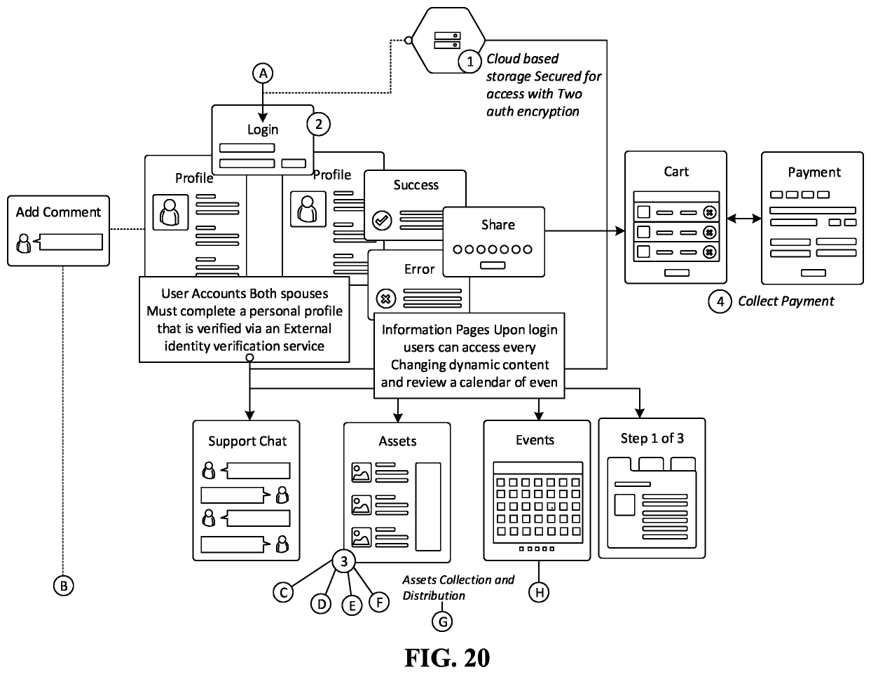

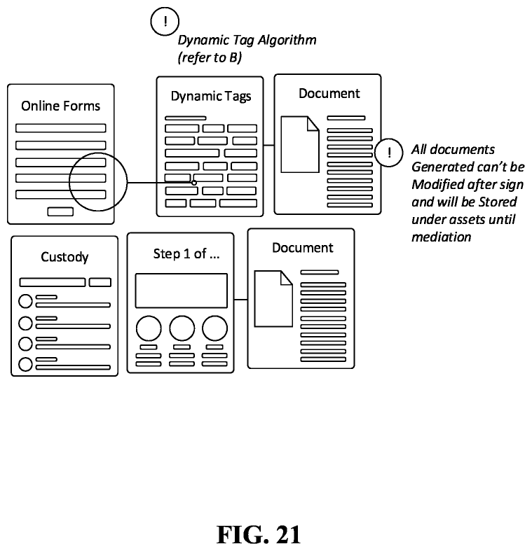

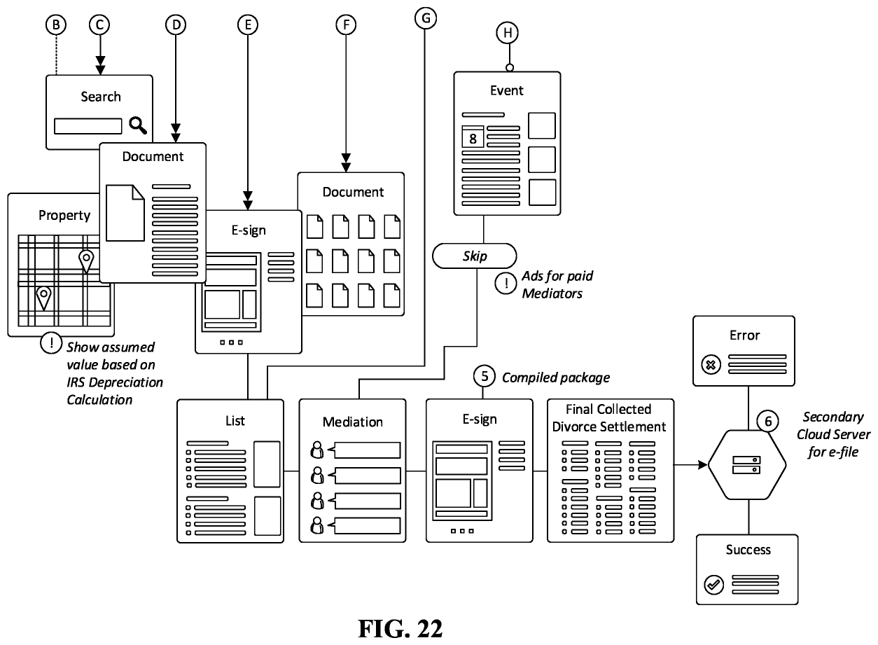

FIGS. 19-22 are user experience flow diagrams for a detailed outline on how a user will navigate through the website, in accordance with some embodiments.

iDivorceU provides a truly unique experience that starts the moment the user creates an account. The primary unique features shown in FIG. 19-22 are listed below:
Multi-server secure document storage.
Legal verbiage dynamic tag suggestion while typing in line.
Property value assessment based on IRS latest depreciation tables.
Mediator and third-party lawyer ads placed programmatically at key points throughout the process based on the user's needs.
Electronic file capable upon final agreement.
Real time chat enabled with internal staff or third-party experts as an additional revenue stream.
Completely unique step by step walkthrough for both parties throughout the process.
Dual party cooperation but individual accounts.

Although the present disclosure has been explained in relation to its preferred embodiment, it is to be understood that many other possible modifications and variations can be made without departing from the spirit and scope of the disclosure.

What is claimed is:

1. A method for facilitating processing of a divorce between two parties, the method comprising:
receiving, using a communication device, a divorce request for initiating the divorce from at least one of a first device and a second device associated with at least one a first party of the two parties and a second party of the two parties;
retrieving, using a storage device, a divorce form based on the divorce request, wherein the divorce form facilitates collecting of information from the two parties for the processing of the divorce;
transmitting, using the communication device, the divorce form to at least one of the first device and the second device;
receiving, using the communication device, at least one of at least one first party information associated with the first party and at least one second party information associated with the second party from at least one first device and the second device;
analyzing, using a processing device, at least one of the at least one first party information and the at least one second party information based on at least one divorce law;
determining, using the processing device, a type of the divorce based on the analyzing;
generating, using the processing device, a divorce solution for proceeding with the divorce based on the determining; and
transmitting, using the communication device, the divorce solution to at least one of the first device and the second device.

2. The method of claim 1 further comprising:
receiving, using the communication device, a response associated with the divorce solution from at least one of the first device and the second device;
generating, using the processing device, a divorce settlement agreement for the two parties based on the response and at least one of the at least one first party information and the at least one second party information; and
transmitting, using the communication device, the divorce settlement agreement to at least one authority device associated with at least one authority, wherein the at least one authority grants the divorce based on the divorce settlement agreement.

3. The method of claim 1, wherein at least one of the at least one first party information and the at least one second party information comprises a location identifier of a location associated with at least one of the first party and the second party, wherein the method further comprises:
determining, using the processing device, a jurisdiction associated with at least one of the first party and the second party for the divorce based on the at least one location identifier; and
identifying, using the processing device, the at least one divorce law applicable in the jurisdiction based on the determining of the jurisdiction, wherein the analyzing of at least one of the at least one first party information and the at least one second party information is further based on the identifying.

4. The method of claim 3 further comprising:
identifying, using the processing device, at least one authority providing the divorce based on the determining of the jurisdiction; and
retrieving, using the storage device, at least one authority information of the at least one authority based on the identifying, wherein the generating of the divorce solution is further based on the retrieving of the at least one authority information, wherein the divorce solution comprises the at least one authority information for proceeding with the divorce.

5. The method of claim 1 further comprising:
generating, using the processing device, a legal forecast for a legal proceeding of the divorce based on the determining; and
transmitting, using the communication device, the legal forecast to at least one of the first device and the second device.

6. The method of claim 1 further comprising:
identifying, using the processing device, at least one divorce issue associated the divorce based on the analyzing;
generating, using the processing device, at least one settlement for the at least one divorce issue based on the at least one divorce law;
transmitting, using the communication device, the at least one settlement to at least one of the first device and the second device;
receiving, using the communication device, at least one of a first party response and a second party response for the at least one settlement from at least one of the first device and the second device; and
analyzing, using the processing device, at least one of the first party response and the second party response, wherein the determining of the type of the divorce is further based on the analyzing of at least one of the first party response and the second party response.

7. The method of claim 6 further comprising:
receiving, using the communication device, at least one data from at least one external device associated with at least one of the first party and the second party;
analyzing, using the processing device, the at least one data; and
determining, using the processing device, at least one indicator of at least one of an improper utterance and an improper action made by at least one of the first party and the second party, wherein the generating of the at least one settlement is further based on the determining of the at least one indicator.

8. The method of claim 1 further comprising identifying, using the processing device, at least one mediator of a plurality of mediators based on the determining of the type of the divorce, wherein the plurality of mediators facilitate mediation between the two parties for the divorce, wherein the generating of the divorce solution is further based on the identifying of the at least one mediator, wherein the divorce solution comprises the at least one mediator for the mediation between the two parties.

9. The method of claim 8 further comprising:
retrieving, using the storage device, a plurality of mediator information associated with the plurality of mediators;
analyzing, using the processing device, the plurality of mediator information based on at least one of the at least one first party information and the at least one second party information; and
determining, using the processing device, an involvement of each mediator of the plurality of mediators with at least one of the first party and the second party based on the analyzing of the plurality of mediator information, wherein the identifying of the at least one mediator is further based on the determining of the involvement.

10. The method of claim 1 further comprising:
retrieving, using the storage device, at least one historical divorce case based on the determining of the type of the divorce; and
analyzing, using the processing device, the at one historical divorce case based on at least one machine learning algorithm, wherein the generating of the divorce solution is further based on the analyzing of the at least one historical divorce case.

11. A system for facilitating processing of a divorce between two parties, the system comprising:
a communication device configured for:
receiving a divorce request for initiating the divorce from at least one of a first device and a second device associated with at least one a first party of the two parties and a second party of the two parties;
transmitting a divorce form to at least one of the first device and the second device;
receiving at least one of at least one first party information associated with the first party and at least one second party information associated with the second party from at least one first device and the second device; and
transmitting a divorce solution to at least one of the first device and the second device;
a storage device communicatively coupled with the communication device, wherein the storage device is configured for retrieving the divorce form based on the divorce request, wherein the divorce form facilitates collecting of information from the two parties for the processing of the divorce; and
a processing device communicatively coupled with the communication device and the storage device, wherein the processing device is configured for:
analyzing at least one of the at least one first party information and the at least one second party information based on at least one divorce law;
determining a type of the divorce based on the analyzing; and
generating the divorce solution for proceeding with the divorce based the determining.

12. The system of claim 11, wherein the communication device is further configured for:
receiving a response associated with the divorce solution from at least one of the first device and the second device; and
transmitting a divorce settlement agreement to at least one authority device associated with at least one authority, wherein the at least one authority grants the divorce based on the divorce settlement agreement, wherein the processing device is further configured for generating the divorce settlement agreement for the two parties based on the response and at least one of the at least one first party information and the at least one second party information.

13. The system of claim 11, wherein at least one of the at least one first party information and the at least one second party information comprises a location identifier of a location associated with at least one of the first party and the second party, wherein the processing device is further configured for:
determining a jurisdiction associated with at least one of the first party and the second party for the divorce based on the at least one location identifier; and
identifying the at least one divorce law applicable in the jurisdiction based on the determining of the jurisdiction, wherein the analyzing of at least one of the at least one first party information and the at least one second party information is further based on the identifying.

14. The system of claim 13, wherein the processing device is further configured for identifying at least one authority providing the divorce based on the determining of the jurisdiction, wherein the storage device is further configured for retrieving at least one authority information of the at least one authority based on the identifying, wherein the generating of the divorce solution is further based on the retrieving of the at least one authority information, wherein the divorce solution comprises the at least one authority information for proceeding with the divorce.

15. The system of claim 11, wherein the processing device is further configured for generating a legal forecast for a legal proceeding of the divorce based on the determining, wherein the communication device is further configured for transmitting the legal forecast to at least one of the first device and the second device.

16. The system of claim 11, wherein the processing device is further configured for:
identifying at least one divorce issue associated the divorce based on the analyzing;
generating at least one settlement for the at least one divorce issue based on the at least one divorce law; and
analyzing at least one of a first party response and a second party response, wherein the determining of the type of the divorce is further based on the analyzing of at least one of the first party response and the second party response, wherein the communication device is further configured for:
transmitting the at least one settlement to at least one of the first device and the second device; and
receiving at least one of the first party response and the second party response for the at least one settlement from at least one of the first device and the second device.

17. The system of claim 16, wherein the communication device is further configured for receiving at least one data from at least one external device associated with at least one of the first party and the second party, wherein the processing device is further configured for:
analyzing the at least one data; and
determining at least one indicator of at least one of an improper utterance and an improper action made by at least one of the first party and the second party, wherein the generating of the at least one settlement is further based on the determining of the at least one indicator.

18. The system of claim 11, wherein the processing device is further configured for identifying at least one mediator of a plurality of mediators based on the determining of the type of the divorce, wherein the plurality of mediators facilitate mediation between the two parties for the divorce, wherein the generating of the divorce solution is further based on the identifying of the at least one mediator, wherein the divorce solution comprises the at least one mediator for the mediation between the two parties.

19. The system of claim 18, wherein the storage device is further configured for retrieving a plurality of mediator information associated with the plurality of mediators, wherein the processing device is further configured for:
analyzing the plurality of mediator information based on at least one of the at least one first party information and the at least one second party information; and
determining an involvement of each mediator of the plurality of mediators with at least one of the first party and the second party based on the analyzing of the plurality of mediator information, wherein the identifying of the at least one mediator is further based on the determining of the involvement.

20. The system of claim 11, wherein the storage device is further configured for retrieving at least one historical divorce case based on the determining of the type of the divorce, wherein the processing device is further configured for analyzing the at one historical divorce case based on at least one machine learning algorithm, wherein the generating of the divorce solution is further based on the analyzing of the at least one historical divorce case.
